(19) United States
(12) Patent Application Publication
(10) Pub. No.: US 2011/0244152 A1
(43) Pub. Date: Oct. 6, 2011

(54) INTEGRATION OF ENTOMOLOGICAL REPELLENT INTO MANUFACTURING PROCESSES OF CORRUGATED CARDBOARD PRODUCTS

(75) Inventor: Brian W. Killebrew, Raleigh, NC (US)

(73) Assignee: Lenovo (Singapore) Pte. Ltd., Singapore (SG)

(21) Appl. No.: 12/750,984

(22) Filed: Mar. 31, 2010

(51) Int. Cl. B32B 1/02; B32B 37/00; B32B 9/00; B32B 3/30; B32B 3/10

(52) U.S. Cl. 428/34.2; 156/60; 428/411.1; 428/172; 428/195.1

(57) ABSTRACT

The integration of insecticide or insect repellent to the adhesive used in the construction of corrugated cardboard boxes/containers and to the application of such repellent to surfaces of at least portions of such boxes/containers. A benefit thus enjoyed is the elimination or minimization of entomological contamination to products, such as sensitive electronic items, shipped in corrugated cardboard boxes/containers.

### BACKGROUND

When computers or other sensitive electronic items, or parts thereof, are shipped long distances, a common concern is insect infestation. This can often be true in the case of such goods being shipped in corrugated cardboard boxes or containers. Insects including, but not limited to, a wide variety of roaches and silverfish, are attracted to adhesives used in the construction of corrugated cardboard boxes/containers as well as to any possible food or water sources that may have migrated into the boxes/containers.

Often, the infestation takes place in electronic items such as computers that already have been assembled, but often as well it takes place in boxes/containers where merely one part or another is being shipped. Either way, functional problems have been noted in computers, other electronic items, or any parts thereof that have been so infested; for instance, the power supply might be compromised when an end user tries to power on.

Typically, adhesives used in the construction of cardboard are starch-based, and thus contain varying amounts or forms of corn, wheat or potato. Such starch-based adhesives indeed serve to significantly attract insects, while if the boxes/containers are shipped in large (e.g., corrugated metal) cargo containers then the moisture and darkness provide an even more inviting space for insects.

### BRIEF SUMMARY

Broadly contemplated herein, at least one presently preferred embodiment, involves the integration of insecticide or insect repellent to the adhesive used in the construction of corrugated cardboard boxes/containers, and to the application of such repellent to surfaces of at least portions of such boxes/containers.

In summary, one embodiment provides a method comprising: securing a first container liner sheet, a container wall interior sheet portion and a second container liner sheet to be adjacent to one another such that the first and second liner sheets sandwich the container wall interior sheet portion therebetween; and introducing a substance comprising entomological repellent to regions among the first container liner sheet, the container wall interior portion and second container liner sheet that will be interior to a space defined between the first and second liner sheets upon performing the securing.

Another embodiment provides an apparatus comprising: a first container liner sheet, a container wall interior sheet portion and a second container liner sheet being secured to be adjacent to one another such that the first and second liner sheets sandwich the container wall interior sheet portion therebetween; and a substance comprising entomological repellent introduced to regions among the first container liner sheet, the container wall interior portion and the second container liner sheet that are interior to a space defined between the first and second container liner sheets.

For a better understanding of exemplary embodiments, together with other and further features thereof, reference is made to the following description, taken in conjunction with the accompanying drawings, and the scope of the claimed embodiments will be pointed out in the appended claims.

### BRIEF DESCRIPTION OF THE SEVERAL VIEWS OF THE DRAWINGS

FIG. 1 illustrates a computer system.

FIG. 2 shows in perspective view a clamshell or laptop computer.

FIG. 3 shows in perspective view the computer of FIG. 2 in latched condition.

FIG. 4 shows in perspective view a clamshell or laptop computer being introduced to a corrugated cardboard container.

FIG. 5 shows a cross sectional view of an edge of the container of FIG. 4, taken from ellipse V in FIG. 4.

FIG. 6 schematically illustrates basic mechanics of a spraying process during assembly of a corrugated cardboard box or container.

FIG. 7 schematically illustrates basic mechanics of a process of applying adhesive during assembly of a corrugated cardboard box or container.

### DETAILED DESCRIPTION

It will be readily understood that the components of the embodiments, as generally described and illustrated in the figures herein, may be arranged and designed in a wide variety of different configurations in addition to the described exemplary embodiments. Thus, the following more detailed description of the embodiments, as represented in the figures, is not intended to limit the scope of the claims, but is merely representative of exemplary embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of the embodiments. One skilled in the relevant art will recognize, however, that the various embodiments can be practiced without one or more of the specific details, or with other methods, components, materials, et cetera. In other instances, well-known structures, materials, or operations are not shown or described in detail to avoid obscuring aspects of the embodiments.

The description now turns to the figures. The illustrated embodiments will be best understood by reference to the figures. The following description is intended only by way of example and simply illustrates certain selected exemplary embodiments as claimed herein.

It should be noted that the flowchart and block diagrams in the figures illustrate the architecture, functionality, and operation of possible implementations of systems, apparatuses, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

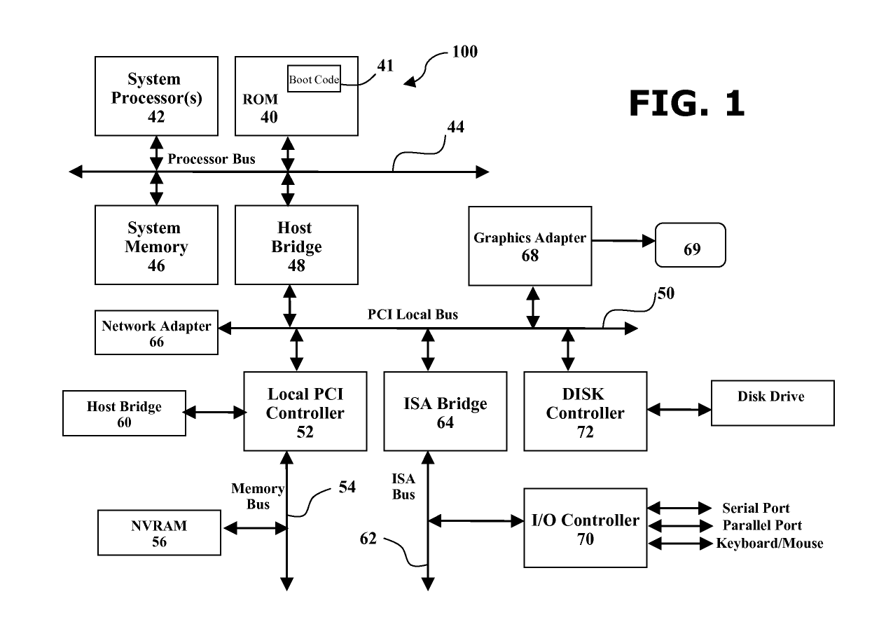

Referring now to FIG. 1, there is depicted a block diagram of an illustrative embodiment of a computer system 100. FIG. 1, by way of an illustrative and non-restrictive example, will help with an appreciation of the types of sensitive internal components of a computer whose functioning might be particularly vulnerable to insect infestation, to the extent that insects might otherwise be attracted to a cardboard container with a computer therein and then migrate into a computer by way of, e.g., a disk drive opening or other opening.

Though particular reference is made to laptop personal computers, it should be understood that the illustrative embodiment depicted in FIG. 1 may be an electronic device such as a laptop or desktop personal computer, a mobile/smart phone or the like.

As shown in FIG. 1, computer system 100 includes at least one system processor 42, which is coupled to a Read-Only Memory (ROM) 40 and a system memory 46 by a processor bus 44. System processor 42, which may comprise one of the AMD line of processors produced by AMD Corporation or a processor produced by INTEL Corporation, is a general-purpose processor that executes boot code 41 stored within ROM 40 at power-on and thereafter processes data under the control of an operating system and application software stored in system memory 46. System processor 42 is coupled via processor bus 44 and host bridge 48 to Peripheral Component Interconnect (PCI) local bus 50.

PCI local bus 50 supports the attachment of a number of devices, including adapters and bridges. Among these devices is network adapter 66, which interfaces computer system 100 to LAN, and graphics adapter 68, which interfaces computer system 100 to display 69. Communication on PCI local bus 50 is governed by local PCI controller 52, which is in turn coupled to non-volatile random access memory (NVRAM) 56 via memory bus 54. Local PCI controller 52 can be coupled to additional buses and devices via a second host bridge 60.

Computer system 100 further includes Industry Standard Architecture (ISA) bus 62, which is coupled to PCI local bus 50 by ISA bridge 64. Coupled to ISA bus 62 is an input/output (I/O) controller 70, which controls communication between computer system 100 and attached peripheral devices such as a as a keyboard, mouse, serial and parallel ports, et cetera. A disk controller 72 connects a disk drive with PCI local bus 50. The USB Bus and USB Controller (not shown) are part of the Local PCI controller (52).

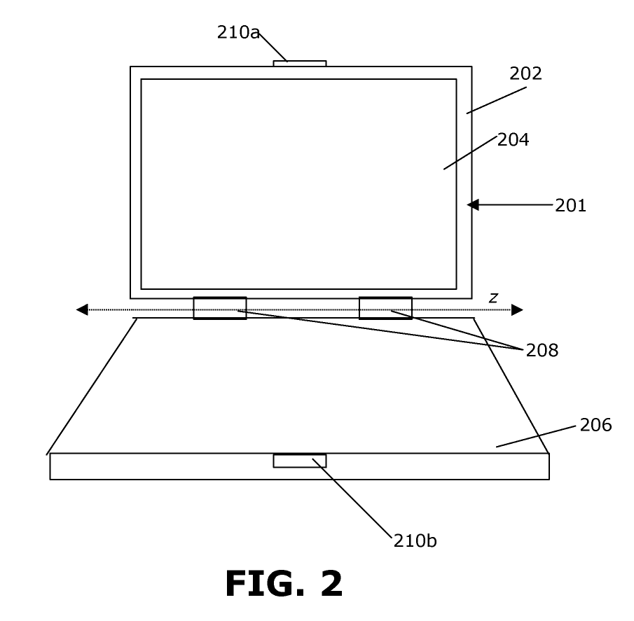

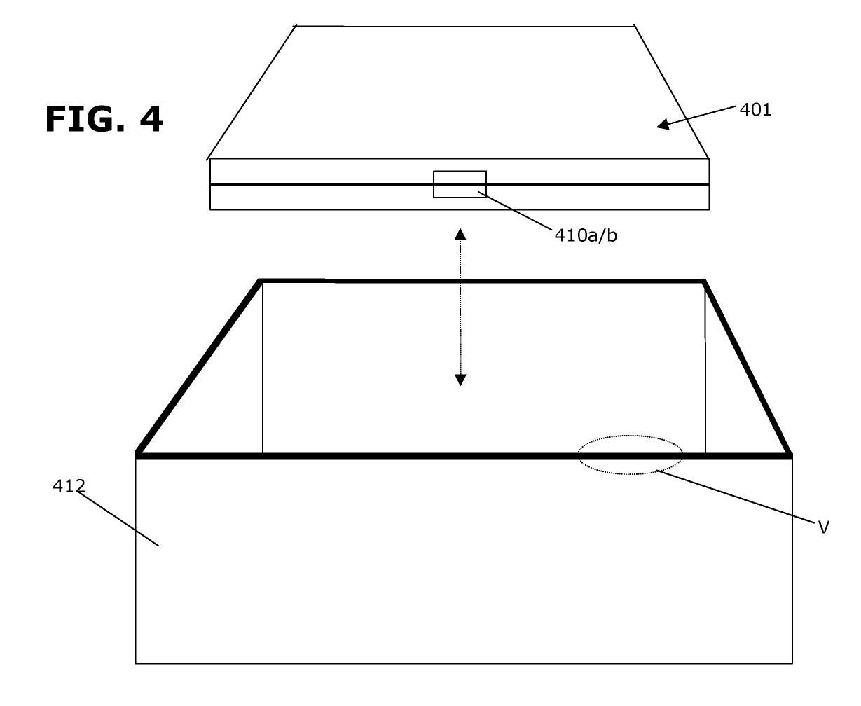

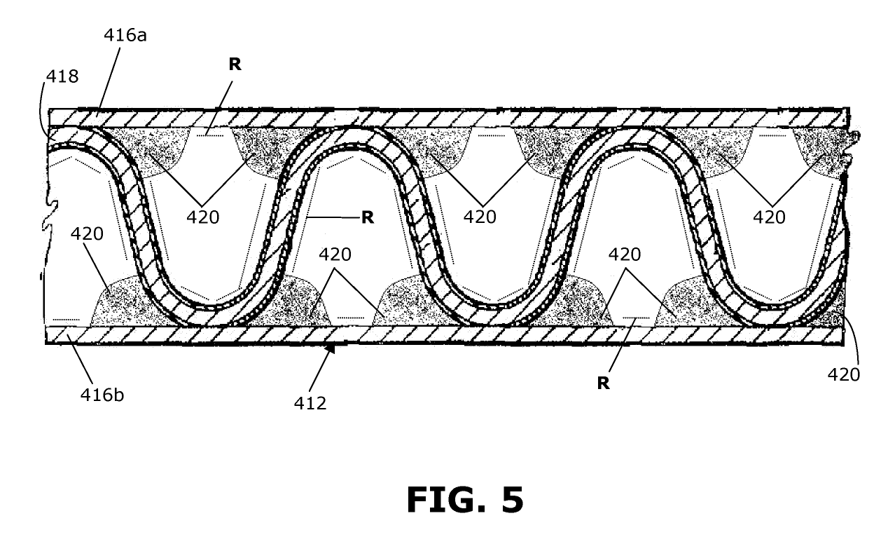

FIG. 2 shows in perspective view a clamshell or laptop computer 200. Generally, it should be noted that for the purposes of discussion herein, the terms “clamshell” and “laptop” may essentially be considered to be interchangeable, referring to a computer with two portions hingedly connected with one another. Also, it should be understood that computer 201 shown in FIG. 2, as well as that indicated at 401 in FIGS. 4 and 5, may be embodied internally by essentially any suitable computer system, such as (but by no means limited to) that indicated at 100 in FIG. 1.

As shown, a clamshell computer may typically include an upper portion 202, which includes screen 204, and a lower portion 206. Upper and lower portions 202/206 are typically hingedly connected w/ one another via suitable hinges 208 or other analogously functioning mechanism(s) for affording relative pivotal displacement of the upper and lower portions 202/206 with respect to one another about a hinge axis z. Typically, as is well-known, lower portion 206 will include a keyboard and other user controls.

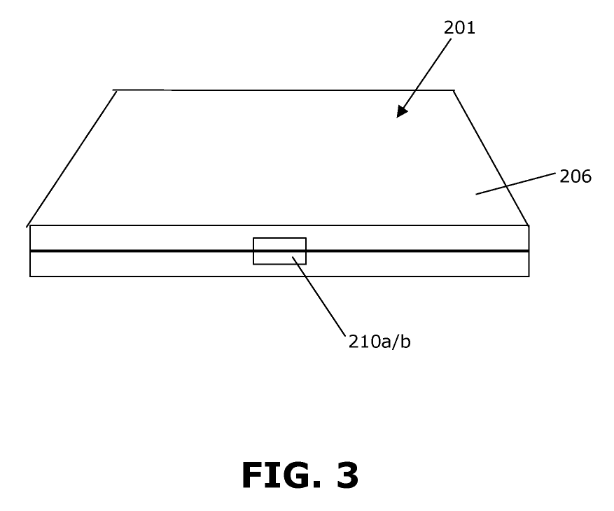

A latch mechanism, with cooperating portions 210a, 210b disposed at upper computer portion 202 and lower computer portion 206, respectively, will typically act to secure the upper and lower portions 202 and 206 with respect to one another, as shown in FIG. 3. Such secured latching, of course, is often not sufficient to prevent insect infestation of the computer 201.

As shown in FIG. 4, a computer 401 (which may be similar in function and makeup to the computer 201 discussed above) latched securingly via latch 410a, 410b (similar to components 210a, 210b discussed above) may be placed in a corrugated cardboard container 412 for shipping.

FIG. 5, for its part, shows a cross sectional view of an edge of container 412 taken from ellipse V in FIG. 4. As can be appreciated from FIG. 5, corrugated cardboard, particularly a cross-section of a side of a corrugated cardboard box or container 412, may typically include three sandwiched parts, namely, first and second liner sheets 416a, 416b which sandwich therebetween a fluted portion, or flute, 418. The flute 418 can be corrugated as shown, with essentially a cross-sectional wave pattern in which apices of the “wave” alternately contact first sheet 416a and second sheet 416b respectively.

Through any of a very wide variety of possible manufacturing processes, typically the flute 418 is secured to first and second sheets 416a, 416b via applications of adhesive 420, typically at portions of flute 418 in the vicinity of the aforementioned wave apices that contact the first and second sheets 416a, 416b.

In accordance with one embodiment, entomological repellent may be incorporated into the adhesive before it is applied, during manufacturing of box or container 412, to the sheets 416a, 416b and/or flute 418 to secure flute 418 to sheets 416a, 416b. This will then ensure that entomological repellent (or essentially any suitable type of insecticide or insect-repelling substance) is internally disposed in walls of box or container 412, to provide an effective barrier against insect migration into the interior of box/container 412.

In accordance with a variant embodiment, as indicated by dotted lines near surfaces of the sheets 416a, 416b and flute 418, an entomological repellent or similar substance may be sprayed onto such surfaces, wherein residue R of the spray will remain on the surfaces. Thus, this can alternatively ensure that entomological repellent or similar substance is internally disposed in the walls of box/container 412.

In accordance with a preferred embodiment, both of the above-discussed measures may be undertaken, that is, both incorporating entomological repellent or similar substance into adhesive 420 and spraying such a substance additionally onto surfaces of portions 416a, 416b and flute 418 to leave a residue R which additionally serves to repel insects and/or prevent their migration into an interior of the box/container 412.

Preferably, the entomological repellent or other substance will be non-toxic, so as not to affect sensitive components of the computer or other sensitive electronic device contained within box/container 412. Thus, an example of an entomological repellent is oil of citronella. Oil of citronella is one nontoxic solution that would not contaminate the contents of the container if the cardboard were damaged.

Another example of non-toxic entomological repellent that may be employed is d-limonene. This may be employed in essentially any suitable concentration, such as about 5.8%. An example of a commercial product containing d-limonene, that may be employed is “ORANGE GUARD”, manufactured by of Carmel Valley, Calif. (http://www.orangeguard.com). “ORANGE GUARD”, in its present incarnation, contains about a 5.8% concentration of d-limonene.

Other examples of non-toxic entomological repellent that may be employed are boric acid and catnip. Catnip, for its part, contains nepetalactone, which is known to be a highly effective roach repellent.

While discussion hereinabove has mainly covered the incorporation of entomological repellent into interiors of walls of corrugated cardboard boxes/containers which transport assembled and latched computers (such as that indicated at 201 in FIG. 3), it should be understood that a similar arrangement of incorporating entomological repellent into interiors of walls of corrugated cardboard boxes/containers which transport other sensitive electronic items, or parts of computers or other sensitive electronic items (prior to their being assembled into a computer or other sensitive electronic item).

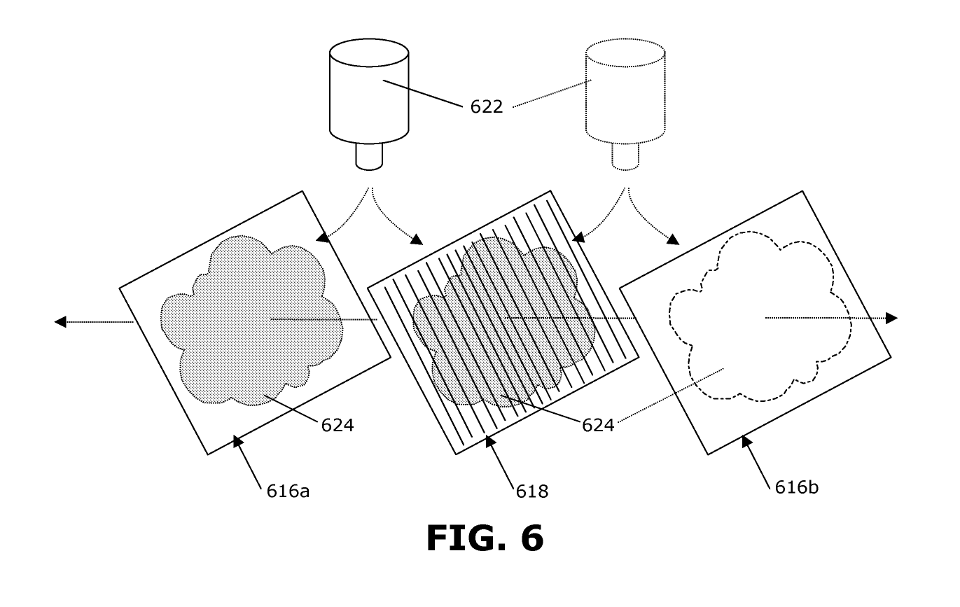

FIG. 6 schematically illustrates basic mechanics of a spraying process in accordance with certain embodiments during assembly of a corrugated cardboard box/container. As shown, prior to their integration and securing with respect to one another, a first liner sheet 616a, a flute 618 and a second liner sheet 616b may be disposed in spaced-apart relation with respect to one another, or otherwise separate from one another, and be separately sprayed upon by one or more spray nozzle arrangements 622. (Sheets 616a, 616b and flute 618 may be similar in makeup and function to sheets and flute 416a/416b/418 shown in FIG. 4.) As discussed above, the spray may contain a non-toxic entomological repellent. Preferably, the spray is sprayed in a manner to leave a residue 624 covering internally-facing surfaces of sheets 616a, 616b (i.e., those faces that will face and otherwise come into contact with flute 618) as well as on both surfaces of flute 618. However, it is also conceivable to spray onto the balance of the surfaces of sheets 616a, 616b as well.

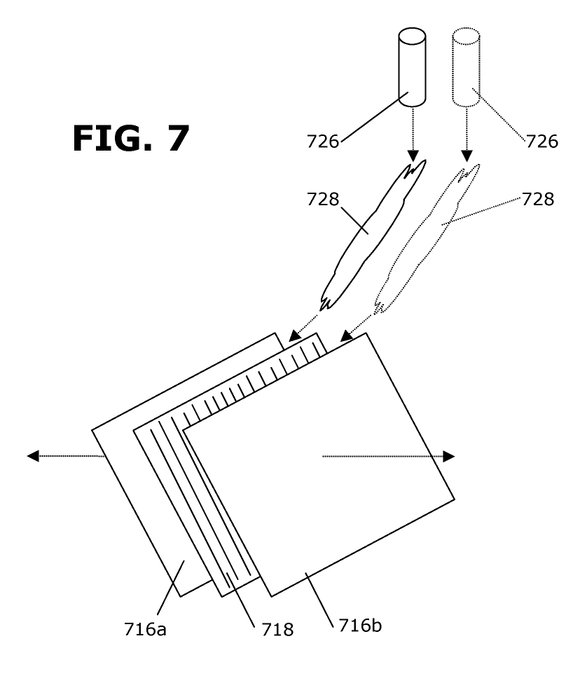

FIG. 7 schematically illustrates basic mechanics of a process of applying adhesive in accordance with certain embodiments, during assembly of a corrugated cardboard box/container. As shown, prior to their integration and securing with respect to one another, a first liner sheet 716a, a flute 718 and a second liner sheet 716b may be disposed in spaced-apart relation with respect to one another, or otherwise separate from one another. (Sheets 716a, 716b and flute 718 may be similar in makeup and function to sheets and flute 416a/416b/418 shown in FIG. 4.) Preferably, adhesive 728, administered, e.g., from one or more suitable adhesive guns or the like 726, is introduced respectively between first sheet 716a and flute 718, and between flute 718 and second sheet 716b. (Whether it is applied specifically only along lines of contact between apices of flute 718 and each sheet 716a, 716b, or applied without such precision, is a matter of choice with respect to the general manufacturing process being used.) As discussed above, the adhesive 728 may contain a non-toxic entomological repellent.

While FIGS. 6 and 7 illustrate the mechanics of different manners of introducing entomological repellent to the interior of walls of corrugated cardboard boxes/containers during manufacture of such boxes/containers, it should be appreciated that both manners may be employed in the same manufacturing process, e.g., via first spraying as shown in FIG. 6 and then applying adhesive as shown in FIG. 7.

Additional variants on the processes described hereinabove of course are contemplated. For instance, a flute portion comprising more than one flute may be employed in the manufacturing of a corrugated cardboard box or container.

It should be noted that the terms “repellent”, “insect repellent” and “entomological repellent”, as broadly employed herein, may be considered to be interchangeable with one another and also with the term “insecticide”.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Although illustrative embodiments have been described herein with reference to the accompanying drawings, it is to be understood that the embodiments are not limited to those particular descriptions, and that various other changes and modifications may be affected therein by one skilled in the art without departing from the scope or spirit of the disclosure.

What is claimed is:

1. A method comprising:
securing a first container liner sheet, a container wall interior sheet portion and a second container liner sheet to be adjacent to one another such that the first and second liner sheets sandwich the container wall interior sheet portion therebetween; and
introducing a substance comprising entomological repellent to regions among the first container liner sheet, the container wall interior portion and second container liner sheet that will be interior to a space defined between the first and second liner sheets upon performing said securing.

2. The method according to claim 1, wherein said container wall interior sheet portion comprises a container wall flute portion.

3. The method according to claim 1, wherein said securing comprises assembling said first container liner sheet, said container wall interior sheet portion and said second container liner sheet into a corrugated cardboard container wall.

4. The method according to claim 1, wherein said securing comprises adhering the first container liner sheet, the container wall interior sheet portion and the second container liner sheet via adhesive.

5. The method according to claim 4, wherein said adhering comprises adhering the first container liner sheet, the container wall interior sheet portion and the second container liner sheet via starch-based adhesive.

6. The method according to claim 4, wherein said introducing the substance comprises said adhering via the adhesive, wherein the adhesive comprises the substance comprising entomological repellent.

7. The method according to claim 6, wherein said introducing further comprises spraying the substance comprising entomological repellent to the regions among the first container liner sheet, the container wall interior portion and the second container liner sheet that will be interior to the space defined between the first and second liner sheets upon performing said securing.

8. The method according to claim 1, wherein said introducing comprises spraying the substance comprising entomological repellent to the regions among the first container liner sheet, the container wall interior portion and second container liner sheet that will be interior to the space defined between the first and second liner sheets upon performing said securing.

9. The method according to claim 1, wherein the entomological repellent comprises a non-toxic entomological repellent.

10. The method according to claim 1, wherein said securing comprises assembling said first container liner sheet, said container wall interior sheet portion and said second container liner sheet into a container for transporting an electronic item.

11. The method according to claim 10, wherein said assembling comprises assembling said first container liner sheet, said container wall interior sheet portion and said second container liner sheet into a container for transporting a computer.

12. The method according to claim 10, wherein said assembling comprises assembling said first container liner sheet, said container wall interior sheet portion and said second container liner sheet into a container for transporting a computer part.

13. The method according to claim 1, wherein said introducing comprises:
introducing a substance comprising entomological repellent to the regions of the surfaces of the first container liner sheet and the container wall interior portion that will face each other upon performing said securing; and
introducing a substance comprising entomological repellent to the regions of the surfaces of the second container liner sheet and the container wall interior portion that will face each other upon performing said securing.

14. An apparatus comprising:
a first container liner sheet, a container wall interior sheet portion and a second container liner sheet being secured to be adjacent to one another such that said first and second liner sheets sandwich said container wall interior sheet portion therebetween; and
a substance comprising entomological repellent introduced to regions among said first container liner sheet, said container wall interior portion and said second container liner sheet that are interior to a space defined between said first and second container liner sheets.

15. The apparatus according to claim 14, wherein said container wall interior sheet portion comprises a container wall flute portion.

16. The apparatus according to claim 14, wherein said first container liner sheet, said container wall interior sheet portion and said second container liner sheet comprise portions of a corrugated cardboard container wall.

17. The apparatus according to claim 14, further comprising an adhesive that adheres said first container liner sheet, said container wall interior sheet portion and said second container liner sheet to one another.

18. The apparatus according to claim 17, wherein said adhesive is a starch-based adhesive.

19. The apparatus according to claim 17, wherein said adhesive comprises said entomological repellent.

20. The apparatus according to claim 19, wherein said substance further comprises an entomological repellent sprayed to the regions among said first container liner sheet, said container wall interior portion and said second container liner sheet interior to the space defined between said first and second liner sheets.

21. The apparatus according to claim 14, wherein said substance further comprises an entomological repellent sprayed to the regions among said first container liner sheet, said container wall interior portion and said second container liner sheet interior to the space defined between said first and second liner sheets.

22. The apparatus according to claim 14, wherein said entomological repellent comprises non-toxic entomological repellent.

23. The apparatus according to claim 14, wherein said first container wall liner sheet, said container wall interior sheet portion and said second container wall liner sheet comprise portions of a wall of a container for transporting an electronic item.

24. The apparatus according to claim 23, wherein said first container wall portion, said container wall interior sheet portion and said second container wall portion comprise portions of a wall of a container for transporting a computer.

25. The apparatus according to claim 23, wherein said first container wall liner sheet, said container wall interior sheet portion and said second container wall liner sheet comprise portions of a wall of a container for transporting a computer part.

26. The apparatus according to claim 14, wherein said substance is disposed:
at regions of surfaces of said first container liner sheet and said container wall interior portion that face each other; and
at regions of surfaces of said second container liner sheet and said container wall interior portion that face each other.
